(19) United States
(12) Patent Application Publication
(10) Pub. No.: US 2014/0329974 A1
(43) Pub. Date: Nov. 6, 2014

(54) BIOPLASTIC COMPOSITION

(71) Applicant: LG Hausys, Ltd., Yeongdeungpo-gu, Seoul (KR)

(72) Inventors: Jung Seop Lim, Gunpo-si (KR); Eung Kee Lee, Anyang-si (KR); Min Hee Lee, Gunpo-si (KR); Chang Hak Shin, Seoul (KR); Ku Il Park, Yongin-si (KR)

(73) Assignee: LG Hausys, Ltd., Yeongdeungpo-gu, Seoul (KR)

(21) Appl. No.: 14/367,177

(22) PCT Filed: Dec. 18, 2012
(86) PCT No.: PCT/KR2012/011088

§ 371 Date: Jun. 19, 2014

(30) Foreign Application Priority Data
Dec. 26, 2011 (KR) 10-2011-0142745

(51) Int. Cl. C08L 67/04

(52) U.S. Cl. CPC C08L 67/04
USPC 525/450

(57) ABSTRACT

The present invention relates to a bioplastic composition, and more particularly to a bioplastic composition comprising a blended resin in which a polylactic acid resin is mixed with a polyhydroxy alkanoate resin.

### TECHNICAL FIELD

The present invention relates to a bioplastic composition, more particularly to a bioplastic composition comprising a blended resin in which a polylactic acid resin is mixed with a polyhydroxy alkanoate resin.

### BACKGROUND ART

Biodegradable plastics are hard plastics biodegrading from degrading elements, which microorganisms emit after a fixed time after disposal. Prior shopping bags, plastic bottles, etc. do not permanently degrade and are becoming a serious issue of environmental problems, but bioplastics have high expectations as it provides clues to solving environmental problems thereof. But, rather, there are many cases where bioplastics with poor physical properties are manufactured because compatibility between resin compositions such as polylactic acid (PLA), polyhydroxy alkanoate (PHA), polybutylene adipate terephthalate (PBAT), etc. forming the bioplastics is poor.

Korea laid-open patent No. 10-2008-0071109 also provides compatibility additives and a method for manufacturing the same that improves polymer compatibility, and PLA, PHA, and polybutylenesuccinate (PHB) are comprised as compatibility additives, but blended resin, etc. to improve compatibility between the additives are not disclosed. And also, Korea laid-open patent No. 10-2011-0017780 discloses about environmental friendly resin compositions comprising PLA, PHA, PBS, etc., but does not disclose blending and appropriate ratios during blending between the biodegradable resins.

Therefore, development of appropriate blending ratios between the biodegradable resins providing excellent compatibility between compositions comprising bioplastics or new additives providing excellent compatibility is encouraged.

### DISCLOSURE

### Technical Problem

An objective of the present invention is to provide a bioplastic composition with improved flexibility, chemical resistance, and thermal resistance, by solving compatibility problems between PLA, PHA, PBAT, etc. described above.

### Technical Solution

A bioplastic composition in accordance with an embodiment of the present invention to achieve the described objective comprises a blended resin in which a polylactic acid resin is mixed with a polyhydroxy alkanoate resin.

A bioplastic composition in accordance with another embodiment of the present invention to achieve the described objective comprises a reactive compatibilizer.

### Advantageous Effects

The bioplastic composition in accordance with the present invention solves degradation of physical properties occurring from compatibility problems between resins such as PLA, PHA, PBAT, etc. by comprising a blended resin with a fixed mixing ratio even without comprising compatibilizers, and especially having biodegradability, flexibility, chemical resistance, and thermal resistance by comprising compatibilizers, and may provide a bioplastic composition with excellent compatibility.

Therefore, utilization of the bioplastics may be broadened, and there are additional effects of being able to be used in a variety of applications by being applied to new bioplastic products.

### DESCRIPTION OF DRAWINGS

FIG. 1 is a graph illustrating storage modulus according to analysis from DMA.

FIG. 2 is a graph illustrating temperature dependence according to storage modulus.

FIG. 3 is a graph illustrating loss modulus according to analysis from DMA.

### BEST MODE

Advantages and features of the present invention, and methods for achieving thereof will be apparent with reference to the accompanying figures and detailed descriptions that follow. But, it should be understood that the present invention is not limited to the following embodiments and may be embodied in different ways, and that the embodiments are given to provide complete disclosure of the invention and to provide thorough understanding of the invention to those skilled in the art, and the scope of the invention is limited only by the accompanying claims and equivalents thereof. Like components will be denoted by like reference numerals throughout the specification.

Hereinafter, a bioplastic composition in accordance with the present invention will be described in detail.

A bioplastic composition in accordance with an embodiment of the present invention comprises a blended resin in which a polylactic acid resin is mixed with a polyhydroxy alkanoate resin.

The polyhydroxy alkanoate resin comprised in the blended resin of the present invention is aliphatic polyester comprising hydroxy alkanoate monomer, which is a repeating unit, expressed as the following chemical formula 1.

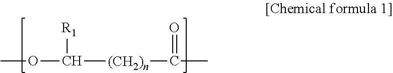

(In the chemical formula 1, R1 is hydrogen atom, or substituted or unsubstituted alkyl group having 1 to 15 carbon atoms, and n is integer of 1 or 2)

The polyhydroxy alkanoate resin may be comprised of homopolymer of hydroxy alkanoate monomer. For detailed examples of the hydroxy alkanoate monomer, 3-hydroxy butyrate, which is a methyl group, for R1 and 1 for n in the Chemical formula 1,3-hydroxy valerate, which is a ethyl group, for R1 and 1 for n, 3-hydroxy hexanoate, which is a propyl group, for R1 and 1 for n, 3-hydroxy octanoate, which is an ethyl group, for R1 and 1 for n, 3-hydroxy octadecanoate, which is an alkyl group having 15 carbon atoms and 1 for n, etc. may be given, and preferably, 3-hydroxy butyrate may be used.

When the hydroxy alkanoate monomer is a main monomer forming the polyhydroxy alkanoate resin of the present invention, same types of monomers such as the following [Chemical formula 2] to [Chemical formula 6] may be comprised for co-monomers, but is not limited to this.

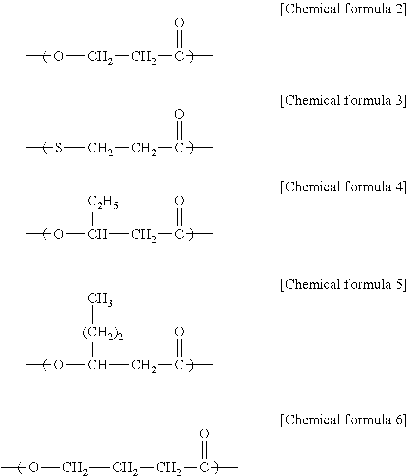

Especially, 10˜20 mol % of the co-monomer may be comprised. When less than 10 mol % of the co-monomer is comprised, there are concerns of workability being difficult or flexibility being low due to limited processing temperature conditions, and there are disadvantages of physical properties of the resin degrading.

The following [Chemical formula 7] to [Chemical formula 11] may be given as examples for the main monomer and polymers for the co-monomer comprising the polyhydroxy alkanoate resin, but is not limited to this. Here, X, Y are integers, and it is preferable for X>Y for securing all of physical strength, impact strength, and heat resistance of the polyhydroxy alkanoate resin. In more detail, it is preferable for the molar fraction for Y with respect to X+Y to be 10˜20 mol %.

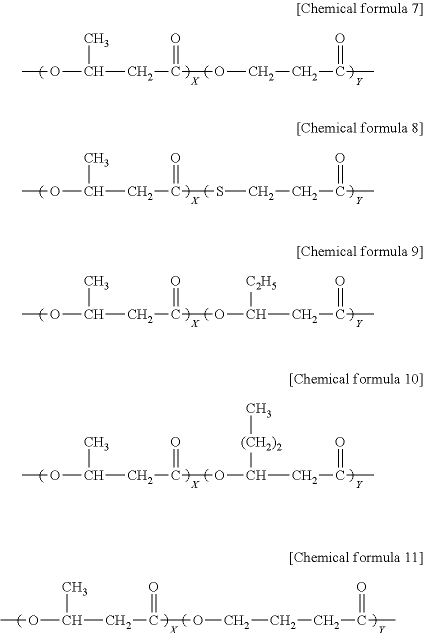

Also, for the polyhydroxy alkanoate resin of the present invention, other than the described polymers, copolymers comprised with 2 or more different hydroxy alkanoate monomers with each other, for example, tri-copolymer, tetra-copolymer, etc., may be given.

3-hydroxy butyrate-co-3-hydroxy hexanoate, which is a copolymer of 3-hydroxy butyrate and 3-hydroxy hexanoate, or 3-hydroxy butyrate-co-3-hydroxy valerate, which is a copolymer of 3-hydroxy butyrate and 3-hydroxy valerate, may be preferably be used for the copolymers comprised with 2 or more different hydroxy alkanoate monomers with each other. Here, it is preferable for the copolymer to be comprised of 80 to 99 mol % of 3-hydroxy butyrate and 1 to 20 mol % of 3-hydroxy hexanoate or 3-hydroxy valerate.

The polylactic acid resin is comprised in the blended resin of the present invention, and has excellent physical strength, and has excellent workability compared to other biodegradable resins and thus is preferable. The polylactic acid is a polyester resin manufactured by ester reaction with a lactic acid as a monomer, and has a structure of the following [Chemical formula 12].

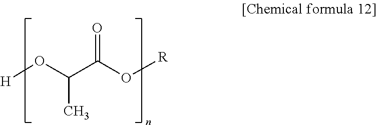

The polylactic acid used for the present invention is composed by comprising a repeat unit derived from L-form lactic acid, a repeat unit derived from D-form lactic acid, or a repeat unit derived from L,D-form lactic acid, and these polylactic acids may be used individually or as a compound.

For an aspect of balancing thermal resistance and moldability, it is advantageous to comprise 95% by weight or more of the repeat unit derived from L-form lactic acid, and more preferably, considering hydrolysis resistance, it is advantageous to use polylactic acid resin comprised of 95 to 100% by weight of the repeat unit derived from L-form lactic acid and 0 to 5% by weight of the repeat unit derived from D-form lactic acid.

The blended resin of the present invention in which the polylactic acid resin is mixed with the polyhydroxy alkanoate resin has excellent physical properties of impact resistance, thermal resistance, etc. compared to when only comprising the polylactic acid resin and the polyhydroxy alkanoate resin, even when a compatibilizer with an appropriate mixing ratio between both resins is not comprised.

The amount of the polylactic acid resin is more than the amount of the polyhydroxy alkanoate resin to increase compatibility of the polylactic acid resin and the polyhydroxy alkanoate resin comprising the blended resin of the present invention. Compatibilities between bioplastic compositions with different properties may be adjusted by the blended resin having an amount of a fixed ratio. Especially, when the amount of the polylactic acid resin is lesser than the amount of the polyhydroxy alkanoate resin, there are concerns that physical properties of the PLA resin may not be improved as much as requested, and there are limits in aspects of price increase of the blended resin.

More particularly, 60 to 90% by weight of the polylactic acid resin and 10 to 40% by weight of the polyhydroxy alkanoate resin may be comprised based on the total bioplastic composition. Especially, comprising 10-20% by weight of the polyhydroxy alkanoate resin is preferable. When the amount of the polyhydroxy alkanoate resin is less than 10% by weight, brittleness of the polyhydroxy alkanoate resin may not be improved, and when the amount of the polyhydroxy alkanoate resin is more than 40% by weight, degradation of physical properties may occur because particles of the polyhydroxy alkanoate resin flocculate as dispersibility is poor. By limiting the inclusion ratio of the polylactic acid resin and the polyhydroxy alkanoate resin fixed, problems of prior bioplastic compositions may be overcome by increasing the compatibility between both resins even when compatibilizers are not comprised.

Meanwhile, the bioplastic composition in accordance with an embodiment of the present invention may comprise reactive compatilizers in the blended resin in which the polylactic acid resin is mixed with the polyhydroxy alkanoate resin. Compatilizers allow polymers to blend well through chemical reaction between composition polymers and functional groups introduced to compatilizers during melting and mixing of polymers. There are two types of compatilizers of non-reactive compatilizers using only physical properties, and reactive compatilizers accompanying reaction during extrusion. The most used of the non-reactive compatibilizers are random copolymers, graft copolymers, block copolymers, etc., and there are many instances of it becoming reactive compatibilizers from reactive groups being attached. There are maleic anhydride, epoxy, carbonyl group, etc. for the reactive group, and this reactive group is mostly attached to an end or a side of the compatilizer. The reactive compatilizer may comprise ionomers in the present invention. Compatibility of the blended resin may be more excellently increased by comprising the reactive compatibilizer, which comprises ionomers, to the blended resin of the present invention, as this shows excellent miscibility and physical properties compared to bioplastic compositions not comprising ionomers. Compared to the compatibilizers becoming excellent when an appropriate range of the polylactic acid resin and the polyhydroxy alkanoate resin is mixed for the bioplastic composition not comprising the reactive compatilizers, the compatibility between both resins may be further improved regardless of the blending ratio of a blended resin when using the reactive compatibilizers comprising ionomers.

The ionomer of the present invention is not particularly limited as long as a small amount of ion group is comprised in a nonpolar polymer chain, but a copolymer of α-olefin and α,β-unsaturated carboxylic acid, a polymer with sulfonic group in polystyrene, a copolymer between α-olefin, α,β-unsaturated carboxylic acid and monomers that may able to be copolymerized with each of these, or one neutralizing these mixtures to monovalent to tetravalent metallic ions are preferable. A manufacturing method for the ionomer resin is well known to those skilled in the arts of the present invention, and is easily purchased commercially.

An ethylene, a propylene, a butene, etc. may be used for the α-olefin, but is not limited to this. These may be used individually or by mixing two or more. The Ethylene is preferable among these. Acrylic acid, methacrylic acid, ethacrylic acid, itaconic acid, maleic acid, etc. may be used for the α,β-unsaturated carboxylic acid, but is not limited to this. These may be used individually or by mixing two or more. Acrylic acid and methacrylic acid are preferable among these.

Acrylic ester, methacrylic ester, stylene, etc may be given for the monomer able to copolymerize, but is not limited to this. Lithium, natrium, potassium, magnesium, barium, lead, tin, zinc, aluminium, ferrous and ferric ions, etc. may be used for the monovalent to tetravalent metallic ions. Lithium, natrium, potassium, zinc, etc. are preferable among these. The amount of acid of the ionomer is 3 to 25% by weight, and preferably 15 to 25% by weight. Surface hardness and tensile strength increase but impact strength reduces since amount of acid increases. It is preferable for the molar fraction of the ion group of the ionomer to be 0.1 to 5 mol % for the ionomers comprised in the reactive compatilizers of the present invention. More particularly, when the molar fraction of the ion group is less than 0.1 mmol %, there are concerns that desired physical properties may not be realized because the amount of the ion group for improving physical properties of resin is small, and when the molar fraction of the ion group of is more than 5 mmol %, there are concerns that physical properties of the resin degrading because cluster is formed among the ion groups.

The compatibilizers comprised in the bioplastic composition of the present invention may further comprise, other than comprising ionomers, reactive compatibilizers having an epoxy group as a reactive group. There are no limits for the compatibilizers with the epoxy group as a reactive group, especially, using one or more selected from the group consisting of glycidyl methacrylate, maleic anhydride, and a mixture thereof is preferable when considering physical properties of the manufactured composition. The glycidyl methacrylate has a structure of [Chemical formula 13], and the maleic anhydride has a structure of [Chemical formula 14].

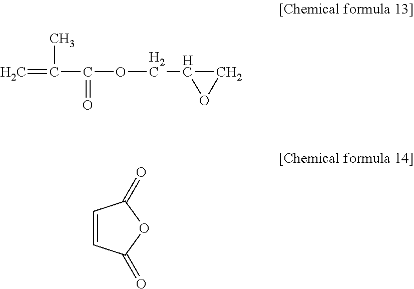

Comprising 1˜20 parts by weight of the compatibilizer of the present invention to 100 parts by weight, based on the total bioplastic composition is preferable, and more preferably 1˜5 parts by weight. When less than 1 parts by weight of compatibilizer is used, physical properties of the product is poor as effect of compatibility increasing drops, and when more than 20 parts by weight is used, non-reactive compatibilizers reduce thermal characteristics of the resin or physical properties may drop as interface between each resin is formed too thick.

Also, the composition may further comprise additives, and here, the additives may be one or more selected from the group consisting of fillers, softening agents, anti-aging agents, heat resisting anti-aging agents, antioxidants, dyes, pigments, and catalyst dispersion agents.

The bioplastic compositions in accordance with the present invention may be completed by the described process, and evaluation results of manufacturing examples (examples and comparative examples) of the bioplastic composition in accordance with the present invention formed as above is as follows.

### EXAMPLES AND COMPARATIVE EXAMPLES

### Example 1

A blended resin was manufactured by, after drying a PLA resin (20002D manufactured by USA NatureWorka LLC) and a PHA resin in a vacuum oven of 70° C., and mixing 90 g of the dried PLA resin and 10 g of the PHA resin. Here, the PHA resin is composed as a copolymer of the [Chemical formula 10], and X=8.0, Y=2.0.

Next, it was fed into a corotating twin screw extruder, then was melt-extruded at a torque of 60N/m at temperature of 180° C., affording a bioplastic composition.

### Example 2

A bioplastic composition was manufactured in the same manner as in Example 1, except for mixing 80 g of the PLA resin, and 20 g of the PHA resin.

### Example 3

A bioplastic composition was manufactured in the same manner as in Example 1, except for mixing 60 g of the PLA resin, and 40 g of the PHA resin.

### Example 4

A bioplastic composition was manufactured in the same manner as in Example 1, except for mixing 10 g of the PLA resin, and 90 g of the PHA resin. Here, 99 mol % of a sucicinic acid, 1 mol % of a SDMF (Sulfonated Di-Methyl Fumarate) and 1,4 butandiol was added to the PHA resin, and an ionomer of 0.5 mol % of the molar fraction of ion group such as [Chemical formula 15] was manufactured, and a blended resin was manufactured by adding 5 g of the ionomer to 10 g of the PLA resin and 90 g of the PHA resin.

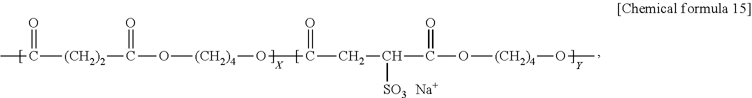

(X=99.5,Y=0.5)

### Example 5

A bioplastic composition was manufactured in the same manner as in Example 2, except for 99 mol % of a sucicinic acid, 1 mol % of a SDMF (Sulfonated Di-Methyl Fumarate) and 1,4 butandiol was added to the PHA resin and an ionomer of 0.5 mol % of a molar fraction of a ion group such as [Chemical formula 15] was manufactured, and a blended resin was manufactured by adding 5 g of the ionomer to 80 g of the PLA resin and 20 g of the PHA resin.

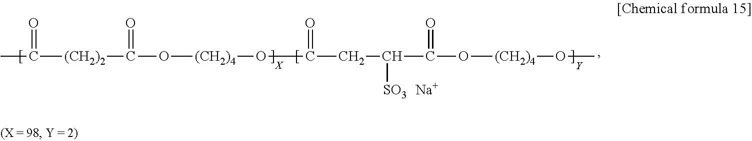

### Comparative Example 1

A PLA resin was manufactured by drying a PLA resin (20002D manufactured by USA NatureWorka LLC) in a vacuum oven of 70° C. for 24 hours and then mixing 100 g of the dried PLA resin.

Next, it was fed into a corotating twin screw extruder, then was melt-extruded at a torque of 60N/m at temperature of 180° C., affording a bioplastic composition.

### Comparative Example 2

A PHA resin was manufactured by drying a PHA resin in a vacuum oven of 70° C. for 24 hours and then mixing 100 g of the dried PLA resin. Here the PHA resin is composed of copolymers of the [Chemical formula 10], and X=8.0, Y=2.0.

Next, it was fed into a corotating twin screw extruder, then was melt-extruded at a torque of 60N/m at temperature of 180° C., affording a bioplastic composition.

### Experimental Example 1

### Analysis by ASTM

Each bioplastic compositions manufactured from the Examples 1 to 5 and Comparative examples 1 to 3 was injection molded, and after a specimen was manufactured by cutting in a size of width 75 mm×height 12.5 mm×thickness 3 mm, and physical strength was measured by Izod method in room temperature conditions based on ASTM D-638, and the results are illustrated in Table 1 below.

TABLE 1

| | PLA:PHA | Tensile Strength: | Toughness: | Elongation |
|---|---|---|---|---|
| | mixing ratio | MPa | MPa | at break: % |
| Example 1 | 9:1 | 45.3 | 47.9 | 87.6 |
| Example 2 | 8:2 | 54.1 | 58.7 | 103.1 |
| Example 3 | 6:4 | 40.1 | 42.4 | 97.6 |
| Example 4 | 1:9 | 56.8 | 70.5 | 105.8 |
| Example 5 | 8:2 | 59.6 | 74.1 | 110.4 |
| Comparative | 10:0 | 22.2 | 3.2 | 3.6 |
| example 1 | | | | |
| Comparative | 0:10 | 19.1 | 4.0 | 5.2 |
| example 2 | | | | |

From the Table 1, the blended resin of Example 1 to Example 3 showing excellent characteristics based on physical properties of elongation strength, toughness, and elongation at break, when an amount of the PLA resin was more than an amount of PHA resin, was observed. This is because physical strength of the bioplastic composition is improved to a degree because the compatibility of the PLA and the PHA was improved to a degree even though compatibilizers are not particularly used when having a fixed range of mixing ratios. Furthermore, it was observed that Example 2 has the optimal mixing ratio with respect to the blended resin of the present invention.

Meanwhile, also when the blended resin has more amount of the PHA resin than the amount of the PLA resin, and when ionomers are used as reactive compatibilizers, identical level to that of Example 2 based on elongation strength, toughness, and elongation at break was shown, and the compatibility of the PLA resin and the PHA resin being increased by using reactive ionomers was observed.

In the case of Example 5, where more amount of the PLA resin than the PHA resin was comprised and reactive compatibilizers comprising ionomers were used, more excellent elongation strength, toughness, and elongation at break compared to Example 1 to 4 were shown, since the effect of the reactive compatibilizers comprising ionomers and the effect of the blended resin appear together, and thus compatibility with the PHA resin and the PLA resin further increases.

In contrast, when only the PLA resin or only the PHA resin is used as in Comparative examples 1 and 2, overall physical strength such as elongation strength, toughness, and elongation at break, etc. being decreased was observed.

### Experimental Example 2

### Analysis by DMA

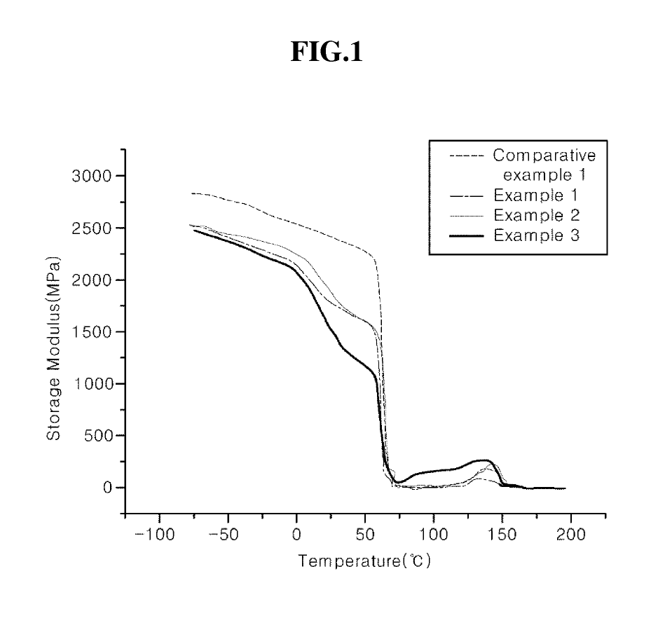

A dynamic mechanical analysis (DMA) is a method describing physical properties of a resin based on a broad range of temperatures, and each of the bioplastic composition manufactured in the Examples 1 to 5 was molded into a film, and after cutting to a size of width 75 mm×height 12.5 mm×thickness 3 mm to manufacture specimens, the graph of storage modulus according temperature and loss modulus according to temperature based on DMA (Vibration: 1 Hz, −Heating speed: 20/min, −Temperature rage: −70° C.-180° C.) are illustrated in FIG. 1 to FIG. 3.

As can be observed in FIG. 1, since the storage modulus value in the case of Examples 1 to 3 comprising the blended resin is smaller than that of Comparative example 1 at same temperatures, it is determined that elastic properties are low, and it may be observed that brittleness of the PLA is improved and compatibility with respect to forming the plastic composition is improved by the reduced elastic properties even though compatibilizers were not used with respect to the blended resin comprising more of the PLA resin.

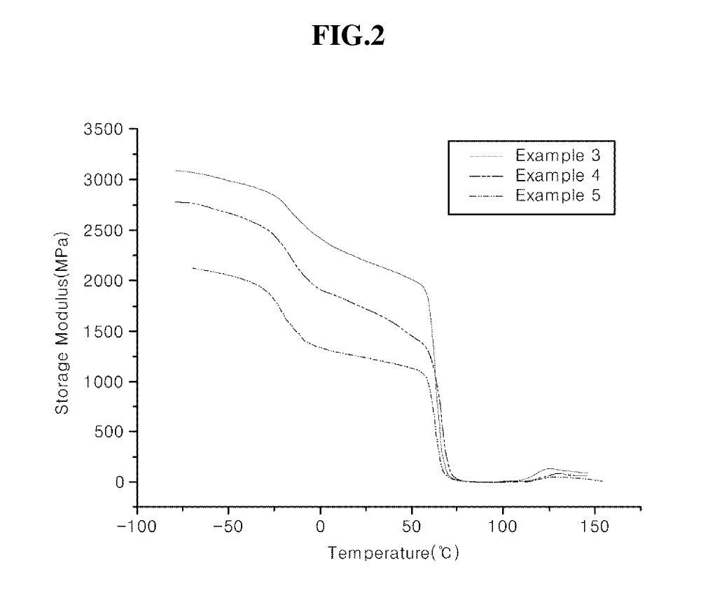

FIG. 2 illustrates the storage modulus according to temperatures of Examples 3 to 5. Compared to Example 3, which does not comprise an ionomer, even when more PLA resin is comprised than the PHA resin, cases of blended resin of Example 4 and Example 5, which comprise reactive compatibilizers comprising ionomers, conducts superior reduction for crystallization of the PHA resin. Also at same temperatures, since the storage modulus is evaluated lower in the case of Example 4 and Example 5 compared to Example 3, according to whether or not comprising ionomers, compatibility becoming excellent and thus being able to be completely blended was observed.

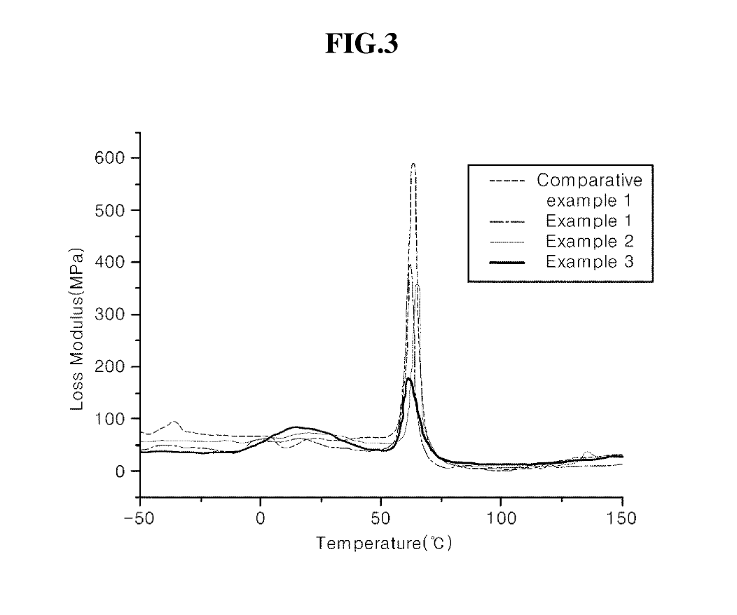

Also, from FIG. 3, since the value of loss modulus is lower in the case of Examples 1 to 3, which comprises the blended resin, compared to Comparative example 1 at same temperatures, viscosity property is low and flexibility increases, and it may be observed that compatibility is good even in cases where compatibilizers are not comprised for forming the plastic compositions from the blended resin with more amount of the PLA resin than the amount of the PHA resin.

Although detailed embodiments in accordance with the present invention have been described herein, it should be understood that various modifications, variations and alterations can be made without departing from the spirit and scope of the invention. Therefore, the scope of the present invention should not be limited to the described embodiments, and should be defined by the appended claims and equivalents thereof.

1. A bioplastic composition comprising a blended resin in which a polylactic acid resin is mixed with a polyhydroxy alkanoate resin.

2. A bioplastic composition according to claim 1, wherein the polyhydroxy alkanoate resin comprises a following chemical formula 1,
wherein R1 is hydrogen atom, or substituted or unsubstituted alkyl group having 1 to 15 carbon atoms, and n is integer of 1 or 2.

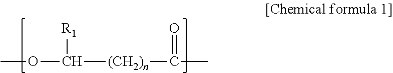

3. A bioplastic composition according to claim 1, wherein the blended resin has an amount of polylactic acid resin more than an amount of polyhydroxy alkanoate resin.

4. A bioplastic composition according to claim 3, wherein the blended resin comprises 60 to 90% by weight of polylactic acid resin and 10 to 40% by weight of polyhydroxy alkanoate resin, based on the total bioplastic composition.

5. A bioplastic composition according to claim 1, wherein the polyhydroxy alkanoate resin comprises co-monomer, and the co-monomer is 10 to 20 mol %.

6. A bioplastic composition according to claim 1, wherein an ionomer is comprised as a reactive compatibilizer.

7. A bioplastic composition according to claim 6, wherein the molar fraction of ion group in the ionomer is 0.1 to 5 mol %.

8. A bioplastic composition according to claim 1, further comprising a reactive compatibilizer having an epoxy group as a reactive group.

9. A bioplastic composition according to claim 8, wherein the reactive compatibilizer having an epoxy group as a reactive group is selected from the group consisting of glycidyl methacrylate, maleic anhydride, and mixtures thereof.

10. A bioplastic composition according to claim 8, wherein the reactive compatibilizer having an epoxy group as a reactive group comprises 1 to 20 parts by weight to 100 parts by weight, based on the total bioplastic composition.
